(19) United States
(12) Patent Application Publication
(10) Pub. No.: US 2009/0307728 A1
(43) Pub. Date: Dec. 10, 2009

(54) SYSTEMS AND METHODS FOR WIRELESSLY TRANSMITTING TELEVISION CONTENT RECEIVED VIA A SATELLITE ANTENNA

(75) Inventors: Jonathan A. Frank, Aurora, CO (US); Max S. Gratton, Lakewood, CO (US)

Correspondence Address: INGRASSIA FISHER & LORENZ, P.C. (DISH), 7010 E. COCHISE ROAD, SCOTTSDALE, AZ, 85253-1406, US

(73) Assignee: DISH NETWORK L.L.C., Englewood, CO (US)

(21) Appl. No.: 12/133,255

(22) Filed: Jun. 4, 2008

(51) Int. Cl. H04N 7/20

(52) U.S. Cl. 725/68

(57) ABSTRACT

Systems and methods allow for wirelessly providing television content from a satellite antenna to a television. An antenna is configured to receive a satellite broadcast signal that includes the television content, and a demodulator coupled to the antenna demodulates the received satellite broadcast signal. A wireless transmitter coupled to the demodulator transmits at least a portion of the demodulated satellite broadcast signal across a wireless connection to thereby allow viewing of the television content on the television.

### TECHNICAL FIELD

The present invention generally relates to satellite antenna systems, and more particularly relates to systems and methods for wirelessly providing television content with a satellite antenna.

### BACKGROUND

Most television viewers now receive their television signals through a content aggregator such as a cable or satellite television provider. For subscribers to a direct broadcast satellite (DBS) service, for example, television programming is received via a broadcast that is sent via a satellite to an antenna that is generally located on the exterior of a home or other structure. A low-noise block feedhorn (LNBF) or similar device typically transmits the received signal from the satellite over a coaxial or similar cable to a set-top box or other receiver associated with the viewer's television. The receiver is then able to extract the desired channel from the content received over the cable connection from the antenna.

While DBS systems have been widely deployed with great commercial and technical success, antenna installation remains a challenge in some settings. In particular, a conventional satellite antenna typically needs to be positioned in a location that has an appropriate line-of-sight to the desired satellites (e.g., a view to the southwest or other portion of the sky). The antenna typically also needs to be connected to an electrical ground (e.g., a ground block of a home or other building) to prevent static discharge through the receiver. Moreover, most antennas use a physical wired connection to the set-top box to facilitate content transfer, and also to provide electrical power to the antenna and LNBF.

If appropriate line-of-sight, grounding and wire access are not readily available, antenna installation can be difficult, if not impossible. In apartment buildings or other forms of shared housing, for example, residents may not have physical or legal access to wall interiors or other areas that would allow for coaxial or other wires to be conveniently placed. Moreover, it is not always convenient to route coaxial cable or other wires to locations that have suitable line-of-sight and electrical ground availability.

It is therefore desirable to create systems and methods for transmitting television content from a satellite antenna to a television that are not subject to the physical and logistical demands of routing cable. These and other desirable features and characteristics will become apparent from the subsequent detailed description and the appended claims, taken in conjunction with the accompanying drawings and this background section.

### BRIEF SUMMARY

Various systems and methods and methods allow for wirelessly providing television content from a satellite antenna to a television. In some embodiments, an antenna is configured to receive a satellite broadcast signal that includes the television content, and a demodulator coupled to the antenna demodulates the received satellite broadcast signal. A wireless transmitter coupled to the demodulator transmits at least a portion of the demodulated satellite broadcast signal across a wireless connection to thereby allow viewing of the television content on the television.

In other embodiments, a satellite antenna system used in providing television content to a viewer watching a television located within a structure is provided. An antenna is located on the exterior of the structure to receive a satellite broadcast signal comprising the television content. A housing that encloses a demodulator, a radio frequency receiver, a tuner and a wireless transmitter is coupled to the antenna and located in proximity to the antenna on the exterior of the structure. The demodulator communicates with the antenna to demodulate the received satellite broadcast signal. The radio frequency receiver receives an instruction from the viewer, and a tuner selects a portion of the demodulated satellite broadcast signal in response to the instruction received from the viewer. A wireless transmitter transmits the selected portion of the demodulated satellite broadcast signal across a wireless connection to thereby allow viewing of the television content on the television.

In still other embodiments, a method of wirelessly providing television content from a satellite antenna system to a remotely-located television is provided. A satellite broadcast signal comprising the television content at the satellite antenna system is received and demodulated at the satellite antenna system. At least a portion of the demodulated satellite broadcast signal from the satellite antenna system is transmitted across a wireless connection to thereby allow viewing of the television content on the television.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a diagram of an exemplary system for wirelessly providing television content to a television;

FIG. 2 is a block diagram of an exemplary satellite antenna system; and

FIG. 3 is a flowchart of an exemplary process for wirelessly providing television content to a remotely-located television.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

According to various embodiments, a satellite antenna system provides television content over a wireless connection rather than a coaxial cable or other wire that needs to be physically routed between the antenna and the television receiver. The wireless connection may be, for example, a television broadcast channel, a wi-fi or similar network connection, a radio frequency (RF) link, or any other wireless connection as appropriate. Because the television and antenna no longer need to be physically connected by a cable or other wire, installation is made easier while the number of locations available for antenna placement is increased.

In a typical hard-wired DBS implementation, a LNBF or the like would receive a transponder signal from one or more satellites. The LNBF would then demodulate the received signal and re-transmit the demodulated transponder content at a different carrier frequency that is more suitable for propagation on the coaxial cable interconnecting the LNBF and a set-top box (STB) or other television receiver. The STB would then extract a particular channel from the received transponder content for presentation on a television or other display. In a conventional hard-wired DBS system, then, the selection and presentation of content on the display is primarily processed by the STB, which is located in proximity to the display rather than at the LNBF or other components located with the satellite antenna. Further, the LNBF typically also receives electrical power for itself and for the antenna from the set-top box via the coaxial cable. By removing the hard-wired connection between the STB and the LNBF, then, a number of issues can arise. Electrical power typically needs to be supplied to the antenna and associated components, for example. Additionally, proper interfaces for wireless communication need to be provided.

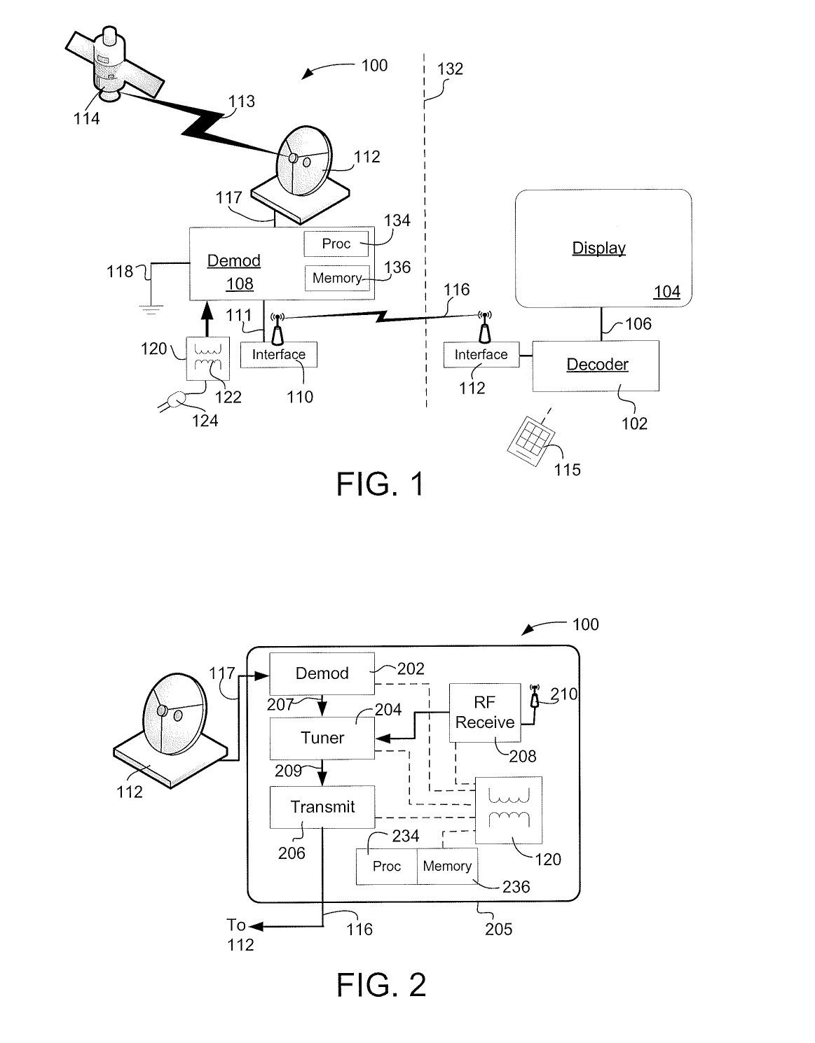

Turning now to the drawing figures and with initial reference to FIG. 1, an exemplary satellite antenna system 100 suitably includes an antenna 112 that receives a downlink signal 113 from one or more satellites 114, as well as an appropriate demodulator 108 and interface 110 to a wireless connection 116. System 100 may also include a power source 120 that provides electrical power to the various components of satellite antenna system 100, as well as suitable electrical grounding 118. The various components of the satellite antenna system 100 are generally found in relatively close physical proximity to each other (e.g., within a common housing or other enclosure, or at least close enough for physical connection). System 100 may be implemented, for example, on the exterior of a home or other structure 132 to facilitate line-of-sight to one or more satellites 114.

Television content received embedded in downlink signal 113 is provided for presentation on a television or other display 104 via wireless connection 116. In the embodiment shown in FIG. 1, television 104 receives a display signal 106 from a set-top box (STB) or other decoder 102. In a conventional DBS television system, decoder 102 would be physically coupled to a LNBF or other demodulator 108 via a coaxial or other cable, and would receive demodulated signals via the cable. In a wireless system, however, television content is provided over a wireless connection 116, which may be interfaced to television 104 in any manner. In the exemplary embodiment shown in FIG. 1, for example, a wireless interface 112 is provided to link decoder 102 to the wireless connection 116. The wireless interface 112 may be, for example, an interface to a wireless network such as an IEEE 802.11 “Wi-Fi” network or the like. In other embodiments, however, an interface 112 and/or decoder device 102 separate from display 104 may not be needed or present. In embodiments wherein wireless connection 116 is a television broadcast channel, for example, interface 112 may be a simple internal or external antenna associated with television 104, and decoder 102 may be a conventional television tuner capable of selecting a very high frequency (VHF), ultra high frequency (UHF), high definition television (HDTV) and/or other channel frequency band as appropriate. Various types of interfaces 112 are described in additional detail below.

The satellite antenna system 100 as shown includes an antenna 112, a demodulating system 108 and wireless interface 110, as well as an appropriate power supply 120 and connection to an electrical ground 118. Antenna 112 is any antenna or set of antennas capable of receiving a downlink signal 113 from one or more satellites 114 as desired. In various embodiments, antenna 112 is a parabolic dish-type antenna such as any of the antennas conventionally used for digital broadcast satellite services, although alternate embodiments may implement antenna 112 in any other manner.

Demodulating system 108 is any device, module, circuitry or other logic capable of receiving and demodulating a signal 117 from antenna 112. In various embodiments, demodulator 108 is a conventional LNBF-type device, although other embodiments (such as those described below) may be implemented with different components or logic. Demodulating system 108 typically includes a processor 134 and associated memory 108 that can be used to perform the demodulation using conventional techniques. Demodulating system 108 may also perform additional functions, such as tuning to particular channel of the demodulated signal, processing received inputs from a viewer, and/or other functions as appropriate, and as described more fully below.

The demodulated satellite broadcast signal, or any portion thereof, may be transmitted across the wireless connection 116 by any sort of interface 110. In various embodiments, interface 110 is a conventional network interface to a wireless data network, such as an IEEE 802.11 “Wi-fi” network. Alternatively, interface 100 may include any sort of radio frequency transmitter/transceiver that is capable of transmitting the demodulated signal to a receiver associated with display 104.

In some embodiments, interface 110 represents a device or other component that may be interposed between a conventional satellite LNBF acting as demodulator 108. Such an interface 110 would typically be located at the same physical site (e.g., on the exterior of a home or other structure) as antenna 112 and LNBF 108, but may have a relatively short coaxial or other wired connection 111 to the LNBF 108. Interface 110 in this embodiment would receive the demodulated broadcast signal via the wired connection 111, and would convert the signal to a format compatible with transmission on wireless connection 116. Such an interface 110 may also include a power supply (e.g., a power supply 120) and would be able to supply electrical power to the LNBF/demodulator 108 via connection 111. In this embodiment, interface 110 could be provided at the same location as a conventional satellite/LNBF to allow for distribution of content over a wireless connection 116 without significant modification to a conventional antenna 112 or LNBF/demodulator 108. That is, the wireless connection 116 would be relatively transparent to the LNBF 108 and antenna 112. In such embodiments, interface 110 may also provide tuner functionality, as described more fully below, to reduce the bandwidth of the signal transmitted on wireless connection 116.

In other embodiments, however, interface 110 simply provides a conventional data or broadcast interface to allow transmission of signals encoding television content. As noted above, any type of wireless connection 116 could be used in various alternate embodiments. For example, demodulated television content may be simply re-broadcast on an unused television channel (e.g., a VHF, UHF, HDTV or other available channel) that can be received and decoded by a television or other display 104. In such embodiments, the viewer would simply tune the receiver to the appropriate channel to view the content rebroadcast by interface 110. One advantage of such a system is that the viewer would not typically need a sophisticated STB or other external receiver other than a conventional television tuner. On the other hand, re-broadcast on open television channels may have licensing implications, and may have security issues as well if other parties in broadcast range would be able to view the same content by simply tuning to the same channel as the intended viewer. This issue may be somewhat mitigated with the use of an optional conditional access module, such as any module present within a television, set-top box, adapter or other component that is able to decrypt or decode broadcast signals that are encoded for privacy using any conventional techniques.

Power supply 120 is any device, circuitry or other module capable of supplying electrical power to any portion of satellite antenna system 100. In various embodiments, power supply 120 includes a conventional plug 124 or other interface to an alternating current (AC) power receptacle. Such a receptacle may be readily available in any home or other structure, and may be used to provide electrical power in the absence of power supplied through coaxial cable or other hardwired connections to a STB or the like. In many embodiments it may be desirable to isolate the supplied AC power from antenna 112 and/or other components of system 100 to prevent static discharge or other issues that may arise. Such isolation may be provided through any type of electrical isolator 122, such as a conventional transformer or the like. Other embodiments of power supply 120 may provide electrical power derived from any other source, such as solar power, wind power or the like. In such embodiments, power supply 120 will typically include a battery or other energy storage device that can be charged by a solar array, wind generator and/or the like, and that can maintain a supply of electrical power even when solar, wind or other energy sources may not be available (e.g., at night). In still other embodiments, power supply 120 simply includes a battery that may be charged or replaced in any manner.

In operation, then, television content is provided from a satellite antenna 112 to a television or other display 104 via a wireless connection 116. The satellite downlink signal 113 is received at antenna 112 and provided to a demodulating system 108 that demodulates the received signal 117. This demodulated signal 111, in turn, can be transmitted over a broadcast channel, a wireless network link or any other wireless connection 116 for eventual presentation to the viewer on display 104. Electrical power for system 100 is typically provided by an on-site power supply 120, which may be a conventional AC power supply or any sort of off-grid energy source.

In various embodiments, satellite antenna system 100 provides additional functionality. With reference now to FIG. 2, an exemplary embodiment of system 100 suitably includes an antenna 112 as described above, as well as a housing or other enclosure 205 that encloses various components. Such components may include, for example, a demodulator 202, a television tuner 204, a radio frequency (RF) receiver 208 and/or a wireless transmitter 206. System 100 may also include an on-site power supply 120 as described above, as well as suitable processing and control capability such as a conventional processor 245 and associated memory or other data storage 236.

Housing 205 is any enclosure capable of supporting components 202, 204, 208 and/or the like in close physical proximity to each other. In various embodiments, housing 205 may be somewhat resistant to dust, moisture, weather and/or other environmental effects to facilitate deployment of system 100 in outdoor environments. That is, the various components located within housing 205 can be provided at the location of antenna 112, such as at the exterior of a home or other structure 132. Television content received via antenna 112 can nevertheless be received, processed, and wirelessly transmitted to a television or other display 104 that may be located within the structure 132 or elsewhere within range of wireless connection 116.

Each of the various components 202, 204, 206, 208 and/or the like within housing 205 may be implemented in a common processing environment (e.g., under the control of processor 234) in various embodiments. In such cases, common data and/or address buses may be provided within housing 206, as well as any conventional addressing and other logical schemes. In other embodiments, components 202, 204, 206, 208 and/or the like are simply discrete components that may be interconnected and jointly and/or separately controlled in any manner.

Demodulator 202 is any device, module or other logic capable of receiving signal 117 from antenna 112 and demodulating the received signal 117 to extract the demodulated transponder signal 207, which typically includes content from several television channels. As noted above, this signal 207 was conventionally sent (often in re-modulated form) to a set-top box or the like associated with the viewer's display 104 over a physical cable or the like.

When using wireless communications, however, it may be desirable in many embodiments to move the tuner function to the satellite antenna system 100, as indicated by tuner module 204 in FIG. 2. By selecting the particular channel to be viewed prior to wireless transmission, the amount of content that needs to be sent over wireless connection 116 can be dramatically reduced. That is, only the desired channel needs to be sent, as opposed to the entire content from the transponder, which may include twenty or more channels in some cases. While some embodiments may retain the tuner function in the television 104 or other decoder 102 (FIG. 1), providing a tuner 204 in the antenna system 100 may dramatically reduce the demands upon wireless communications link 116.

To facilitate tuning of individual channels at the satellite antenna system 100, a receiver 208 may be provided with an associated antenna 210. Receiver 208 is any radio frequency or other receiver that is capable of receiving inputs from a viewer. Typically, such inputs may be provided via a remote control 115 (FIG. 1) or the like that operates on a suitable radio frequency band. While FIG. 2 shows the inputs as being received via a separate receiver 208 and antenna 210 from wireless connection 116, equivalent embodiments (e.g., those based upon IEEE 802.11 protocols) may receive user input signals from a compatible remote control 115 or other device via the same wireless connection 116 used to transmit the television content.

The resulting television content 209 may be transmitted over connection 116 in any manner. To that end, satellite antenna system 100 suitably includes a wireless transmitter 206, which is any sort of transmitter and/or transceiver capable of operating with an appropriate wireless connection 116. In various embodiments, transmitter 206 corresponds to interface 110 in FIG. 1 in that it provides an appropriate network, broadcast or other interface to the wireless connection 116. Transmitter 206 may perform any sort of modulation on any carrier frequency in broadcast implementations, and/or may perform any sort of packetizing or other formatting in conjunction with network-based implementations. In various embodiments, transmitter 206 may also provide channel identification, encryption and/or other features as appropriate.

As noted above, power supply 120 is any device, circuitry and/or other module capable of providing appropriate electrical power to the various components of satellite antenna system 100. To that end, power supply 120 is able to interface with any appropriate AC energy source, or any type of off-grid energy supply such as a battery, solar cell or array, wind generator, fossil fuel generator and/or the like. Appropriate isolation may also be provided, as described in conjunction with FIG. 1 above.

In practice, then, antenna system 100 includes any sort of components or other modules to allow for deployment of a satellite antenna 112 without a physical cable connection to a STB or other decoder 102 associated with a display 104. By placing a power supply and suitable processing components within a common housing 205 that can be deployed in conjunction with antenna 112, a convenient system for processing satellite television signals can be realized.

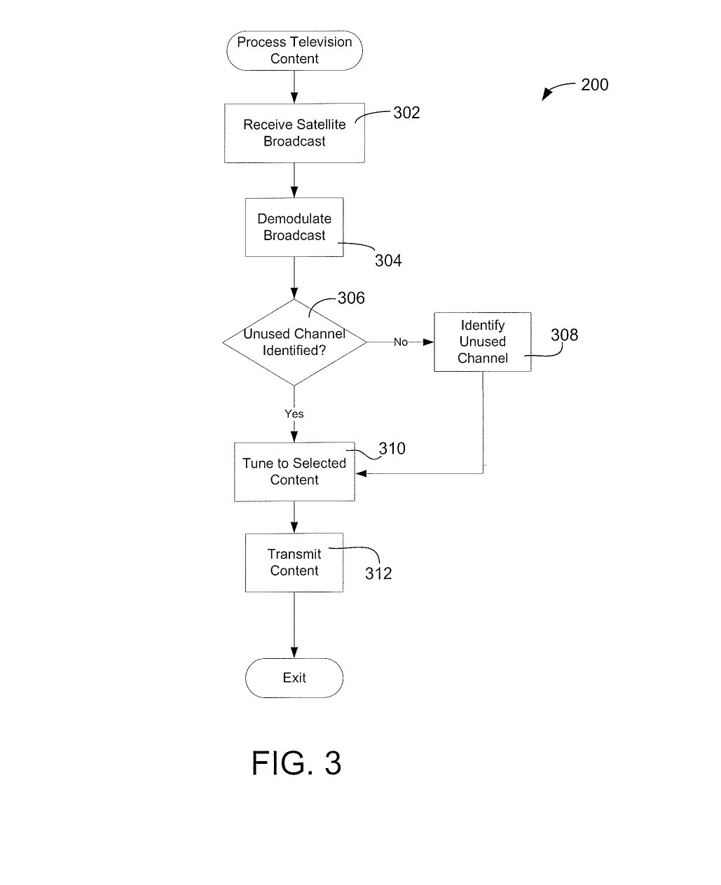

With reference now to FIG. 3, an exemplary method 300 for wirelessly providing television content from an antenna 112 to a remotely-located television 104 suitably includes the broad steps of receiving the satellite broadcast (step 302), demodulating the broadcast (step 304), selecting particular content for transmittal (step 310), and transmitting the content to the viewer over the wireless connection 116 (step 312). Various embodiments may also identify unused broadcast or network channels (steps 306, 308) as appropriate, and/or may provide alternate or additional steps as well.

Method 300 may be executed in any manner. In some embodiments, the various steps of method 300 are implemented using a digital controller (e.g., processor 134 in FIG. 1 or processor 234 in FIG. 2) executing software instructions that may be stored in any memory (e.g., memories 136 and/or 236) or other digital storage medium. In other embodiments, some or all of the various steps are carried out by separate components or modules operating within a common system, such as the satellite antenna system 100 shown in FIGS. 1 and 2. The various steps shown in FIG. 3 may be executed in any temporal order, and some or all of the steps may be executed concurrently. Receiving and demodulating of broadcast signals, for example, will typically take place on a relatively continuous basis while the system is in operation to avoid outages or gaps in service to the viewer. Moreover, tuning of particular content will typically take place on an interrupt-type basis as viewer inputs are received from a remote control or other input device.

Satellite broadcast signals (e.g., signals 113 in FIG. 1) are received in any manner. In various embodiments, the signals 113 are received at a satellite antenna 112 as described above. These signals 113 are typically modulated on a carrier frequency, and will generally be demodulated (step 304) prior to further processing.

Some or all of the demodulated satellite broadcast signal is then transmitted across the wireless connection 116 (steps 312). Before transmission can take place, however, various embodiments may identify an available transmit channel (steps 306, 308) and/or may further tune the demodulated signal to select particular content that can be transmitted over the wireless connection 116.

Certain embodiments may operate using any sort of pre-defined broadcast frequency band(s), network channels, and/or the like. Such parameters may be set forth in accordance with any number of industry standards, for example, or in response to user configuration or other factors as appropriate. In various embodiments implemented over IEEE 802.11 networks, for example, a particular wireless “zone” may be selected by the user, with particular channels, encryption keys, routing addresses and/or other factors defined in accordance with the particular wireless network.

In other embodiments, however, system 100 may identify an unused channel, frequency band or other portion of the wireless connection 116 for subsequent use (step 308). This determination may be based upon observations and/or comparisons of traffic (or lack of traffic) on any channels or frequency bands, upon received signal strength of any signals received on the particular band, and/or upon any other factors as appropriate. In some embodiments, a default channel may be selected at the outset, but this default value may be changed if another user of the channel is identified. For example, a broadcast television implementation may default to UHF channel 50 (or any other channel), unless another broadcast is identified on that particular channel. Similarly, a default IEEE 802.11 channel (e.g., “channel 1”, or any other channel) may be defaulted unless significant network traffic is identified on that channel. Network channel identification (steps 306, 308) need not take place in all embodiments, nor do such steps need to be executed upon every iteration of method 300. That is, once an appropriate channel is identified, it will not typically be necessary to continually re-evaluate the channel selection. Certain embodiments, however, may periodically (or continually) evaluate and/or update the channel selection to ensure adequate signal quality for the viewer and/or to avoid crowding a particular network channel, as appropriate.

As noted in additional detail above, it may be beneficial in some embodiments to tune particular television channels (step 310) at the transmit side of the wireless connection 116 to limit the amount of bandwidth consumed by the transmittal 312. This may be accomplished using the techniques set forth above, for example by receiving a viewer input from an RF remote or similar device. Upon receipt of an input from the viewer, the particular channel may be tuned at the satellite antenna system 100, thereby significantly reducing the amount of content transmitted across wireless connection 116. Again, however, this is not necessarily implemented in all embodiments; some embodiments may simply transmit the entire transponder content across the wireless connection 116 and allow tuning to individual channels at a set top box or other decoder 102, as desired.

Accordingly, various systems and techniques have been described for wirelessly transmitting television content from an antenna system for viewing on a remotely-located television. Using the concepts set forth herein, power and bandwidth management issues may be overcome, thereby freeing the antenna system 100 from the constraints of coaxial or other cables typically required in the prior art. This, in turn, will greatly simplify installation of the satellite antenna system 100 while allowing the antenna 112 to be located at a wider range of locations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A satellite antenna system used in providing television content to a television, the system comprising:
an antenna configured to receive a satellite broadcast signal comprising the television content;
a demodulator coupled to the antenna and configured to demodulate the received satellite broadcast signal; and
a wireless transmitter coupled to the demodulator and configured to transmit at least a portion of the demodulated satellite broadcast signal across a wireless connection to thereby allow viewing of the television content on the television.

2. The satellite antenna system of claim 1 further comprising a tuner configured to select the portion of the demodulated satellite broadcast signal and to provide the selected portion of the demodulated satellite broadcast signal to the wireless transmitter.

3. The satellite antenna system of claim 2 further comprising a radio frequency receiver configured to receive an instruction from a remote control and to provide the instruction to the tuner.

4. The satellite antenna system of claim 3 wherein the antenna, demodulator, wireless transmitter, tuner and radio frequency receiver are configured to be physically coupled to each other at a common location remote from the television.

5. The satellite antenna system of claim 1 further comprising a power source configured to provide electrical power to each of the antenna, the demodulator and the wireless transmitter.

6. The satellite antenna system of claim 5 wherein the power source comprises a battery and a solar energy source configured to charge the battery.

7. The satellite antenna system of claim 5 wherein the power source comprises an adapter configured to receive an alternating current (AC) from a receptacle.

8. The satellite antenna system of claim 7 wherein the power source comprises an isolator configured to electrically isolate the satellite antenna system from the receptacle.

9. The satellite antenna system of claim 1 wherein the wireless connection corresponds to a television broadcast channel.

10. The satellite antenna system of claim 1 wherein the wireless connection is a wireless data network.

11. The satellite antenna system of claim 1 wherein the wireless transmitter is configured to identify an unused portion of the wireless connection.

12. A satellite antenna system used in providing television content to viewer watching a television located within a structure having an exterior, the system comprising:
an antenna configured to be located on the exterior of the structure and to receive a satellite broadcast signal comprising the television content; and
a housing configured to be coupled to the antenna and located in proximity to the antenna at the exterior of the structure;
a demodulator located within the housing and in communication with the antenna, wherein the demodulator is configured to demodulate the received satellite broadcast signal;
a radio frequency receiver located within the housing and configured to receive an instruction from the viewer;
a tuner located within the housing and in communication with the radio frequency receiver, wherein the tuner is configured to select a portion of the demodulated satellite broadcast signal in response to the instruction received from the viewer; and
a wireless transmitter located within the housing and in communication with the tuner, wherein the wireless transmitter is configured to transmit the selected portion of the demodulated satellite broadcast signal across a wireless connection to thereby allow viewing of the television content on the television.

13. The satellite antenna system of claim 12 wherein the wireless connection is a television broadcast channel.

14. The satellite antenna system of claim 12 wherein the wireless connection is a wireless data network.

15. The satellite antenna system of claim 12 further comprising a power source having a plug configured to interface with an alternating current (AC) receptacle associated with the structure and an isolator configured to electrically isolate the satellite antenna system from the receptacle.

16. A method of wirelessly providing television content from a satellite antenna system to a remotely-located television, the method comprising:
receiving a satellite broadcast signal comprising the television content at the satellite antenna system;
demodulating the received satellite broadcast signal at the satellite antenna system; and
transmitting at least a portion of the demodulated satellite broadcast signal from the satellite antenna system across a wireless connection to thereby allow viewing of the television content on the television.

17. The method of claim 16 further comprising tuning to the portion of the demodulated satellite broadcast signal associated with the television content prior to transmitting across the wireless connection.

18. The method of claim 17 wherein the tuning is performed in response to a radio frequency signal received from a viewer of the television.

19. The method of claim 17 further comprising identifying an unused channel in the wireless connection.

20. The method of claim 17 further comprising encrypting the at least a portion of the demodulated satellite broadcast signal prior to transmitting.
